(19) United States
(12) Patent Application Publication
(10) Pub. No.: US 2026/0089084 A1
(43) Pub. Date: Mar. 26, 2026

(54) OPTIMIZING CELLULAR NETWORK SYSTEM CAPACITY

(71) Applicant: T-Mobile USA, Inc., Bellevue, WA (US)

(72) Inventors: Gary Dousson, Seattle, WA (US); Antoine T. Tran, Sammamish, WA (US); Emile Minh Tran, Sammamish, WA (US)

(21) Appl. No.: 18/892,178

(22) Filed: Sep. 20, 2024

(51) Int. Cl. H04L 45/12

(52) U.S. Cl. CPC H04L 45/123

(57) ABSTRACT

A device configured to provide fixed-wireless access (FWA) service to a subscriber of a cellular network is disclosed. The device is configured to operate in the cellular network while concurrently being connected to a local wireless network using an unlicensed spectrum of frequencies, discover a peer device configured to provide FWA service to the subscriber in the local wireless network, establish a connection with the peer device using the unlicensed spectrum of frequencies, determine a first link cost for routing a data packet directly to a network node in the cellular telecommunications network using a spectrum of frequencies licensed for use by the cellular telecommunications network, determine a second link cost for routing the data packet indirectly to the network node via the peer device, and route the data packet based on a comparison of the first link cost and the second link cost.

### BACKGROUND

Cellular network utilization refers to an extent to which the cellular network’s resources, such as bandwidth, are being used at a given moment. It is a measurement of how much of available system capacity of the cellular network is actively being used to transmit data, including traffic generated by applications, devices, or subscribers. High cellular network utilization reduces the available system capacity and can slow down the transmission speed and overall performance of the cellular network, while low or optimal network utilization ensures that the cellular network is performing efficiently and can accommodate more subscriber traffic.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a system diagram of a system in which at least some aspects of the disclosed technology are implemented.

FIG. 4A is a link cost diagram of a system in which at least some aspects of the disclosed technology are implemented.

FIG. 4B is a network peering diagram of a system in which at least some aspects of the disclosed technology are implemented.

FIG. 5A is a flowchart of a process for implementing at least some aspects of the disclosed technology.

FIG. 5B is a flowchart of a process for implementing at least some aspects of the disclosed technology.

FIG. 6 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology pertains to a system for optimizing system capacity in a cellular telecommunications network by offloading traffic to a fixed-wireless access (FWA) mesh network that includes cost-based routing and data caching mechanisms. The disclosed technology includes a plurality of FWA devices—also referred to herein as customer premises equipment (CPE)—configured to provide FWA service located within a vicinity of each other. At least one of the plurality of FWA devices is located within a coverage footprint of at least one Radio Access Network (RAN) network node of the cellular telecommunications network. The cellular telecommunications network can be referred to herein as a cellular network or a mobile network. Each of the plurality of FWA devices is configured to provide FWA service to a subscriber of the cellular network. Each FWA device is further configured to establish an ad hoc network using an unlicensed band of frequencies (i.e., unlicensed spectrum) to communicate directly with at least one other FWA device of the plurality of FWA devices. The ad hoc network can be referred to herein as a peer-to-peer (P2P) network when it includes at least two FWA devices and as a mesh network when it includes at least three FWA devices. In some implementations, the ad hoc network can be established using WiFi (also referred to herein as Wi-Fi) spectrum or protocols.

In some implementations, each of the plurality of FWA devices can advertise to the other FWA devices in the ad hoc network a link cost for sending data from that FWA device to the at least one network node of the cellular network. In some implementations, the link cost can be determined based on at least one of a signal quality metric between the FWA device and the at least one network node of the cellular network, a cellular capacity metric of the at least one network node of the cellular network, or an FWA device capacity metric of the FWA device. In some implementations, a first FWA device of the plurality of FWA devices can determine a link cost for sending data to the at least one network node of the cellular network via a second FWA device of the plurality of FWA devices by adding a link cost for sending data from the first FWA device to the second FWA device, and the link cost advertised by the second FWA device for sending data from the second FWA device to the at least one network node of the cellular network. In some implementations, the first FWA device can determine the link cost for sending data from the first FWA device to the second FWA device based on at least one of a signal quality metric between the first FWA device and the second FWA device, an FWA device capacity metric of the first FWA device, or an FWA device capacity metric of the second FWA device.

In some implementations, the first FWA device can request data stored in a data cache of the second FWA device. In response, the second FWA device can retrieve the data from its data cache and send it to the first FWA device. Both these data transfers can be performed directly between the first and the second FWA devices using unlicensed spectrum or without utilizing resources of the at least one network node of the cellular network. In some implementations, the second FWA device, upon receiving the data request from the first FWA device, can first determine whether the requested data exists in the data cache of the second FWA device and, upon determining that the data does not exist in the data cache, can forward the data request to the at least one network node of the cellular network to retrieve the requested data from a remote server that hosts the data. In some implementations, the second FWA device can store in its data cache at least a subset of data received from at least one of the plurality of FWA devices that comprise the ad hoc network. In some implementations, the second FWA device can store in its data cache at least a subset of data received from the at least one network node of the cellular network. In some implementations, the second FWA device can determine the subset of data to be stored in its data cache based on a probability of the subset of data being requested by the first FWA device.

The inventors have recognized a need to optimize bandwidth utilization in a cellular network by offloading, when possible, some traffic to external network nodes and spectrum resources that do not comprise the cellular network. The inventors have further recognized that such offloading should only be done to the extent that it does not affect subscriber experience and network performance expectations for various types of traffic such as low-latency applications. In addition to optimizing bandwidth utilization, such traffic offloading can also reduce noise and interference in the uplink channels of the cellular network and thus can further improve network performance and capacity of the cellular network. Accordingly, the inventors have proposed the technology disclosed herein, which can be implemented on a plurality of FWA devices that are configured to provide home internet (HINT) service using FWA protocols to subscribers within or beyond the coverage footprint of the cellular network. In some implementations, when the disclosed technology is implemented, the plurality of FWA devices can be configured to establish a local P2P or mesh network between or among them using unlicensed spectrum and protocols such as WiFi. In some implementations, when the disclosed technology is implemented, at least one of the plurality of FWA devices can be configured to maintain a data cache locally within the FWA device. Each of the plurality of FWA devices can advertise a link cost to the other FWA devices to send data to the cellular network via that FWA device. Depending on the type of data to be exchanged, a first FWA device can choose to request the data directly from the cellular network using resources of the cellular network or can choose to request it via a second FWA device of the plurality of FWA devices. For example, when the data to be exchanged is latency-sensitive, the first FWA device can request it from the cellular network. When the data is not latency-sensitive, the first FWA device can request it from the second FWA device. Further, the second FWA device, upon receiving the request from the first FWA device, can first determine if the data exists in its local data cache—if it does, the second FWA device can send it to the first FWA device over the P2P connection without using resources of the cellular network; if it does not, the second FWA device can forward the request to a remote server host of the data via the cellular network.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Wireless Communications System

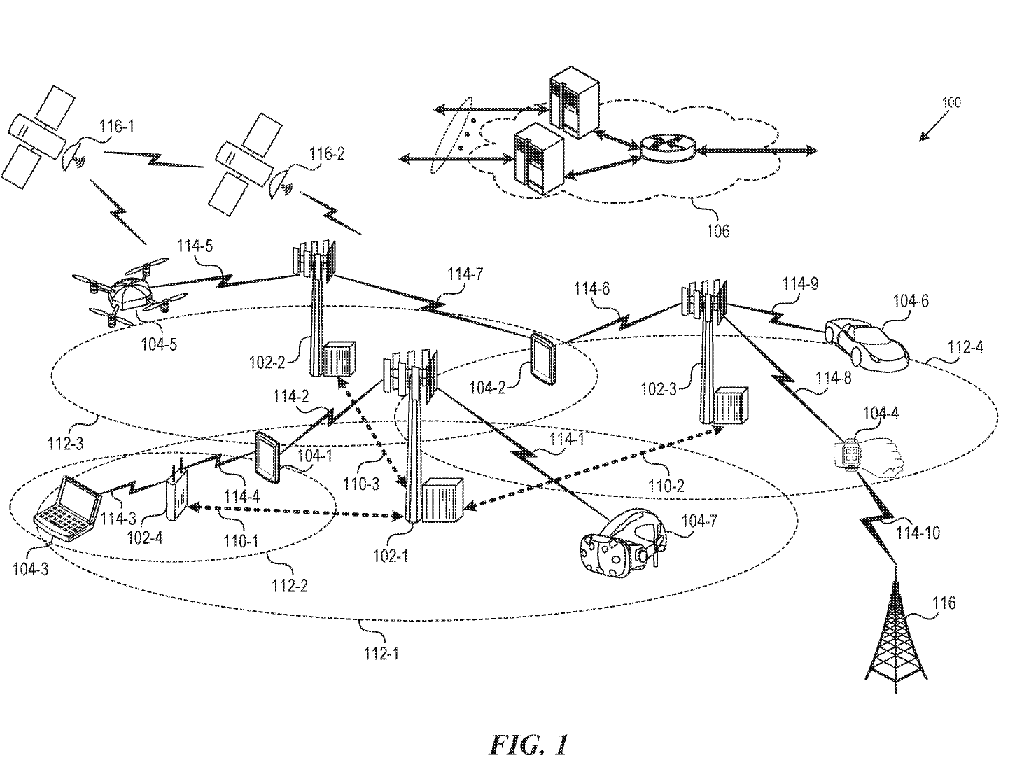

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

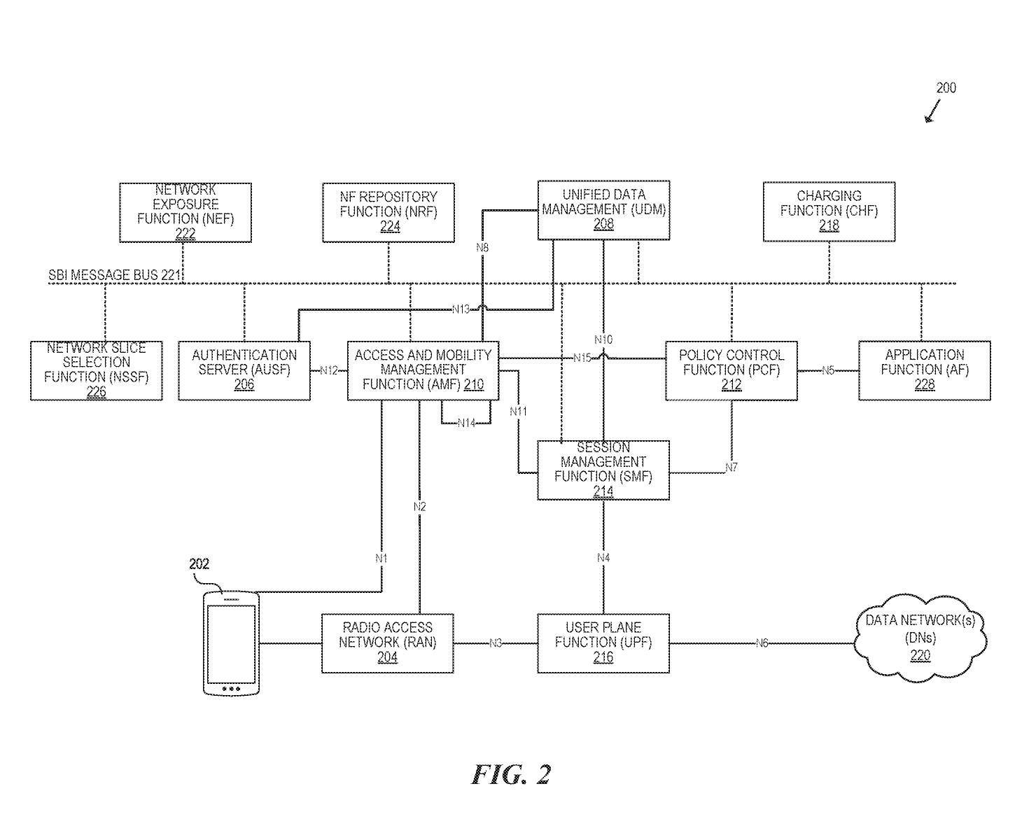

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator’s infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Optimizing Cellular Network System Capacity

Fixed-wireless access (FWA) is a type of wireless technology that enables fixed broadband access using radio frequencies instead of cables. The advantages of FWA include the ability to connect with users in remote areas without the need for laying new cables and the capacity for broad bandwidth that is not impeded by fiber or cable capacities. A mesh network is a local area network topology in which the infrastructure nodes (e.g., bridges, switches, and other infrastructure devices) connect directly, dynamically, and non-hierarchically to as many other nodes as possible and cooperate with one another to efficiently route data to and from clients. This lack of dependency on a single node allows for every node to participate in the relay of information. Mesh networks dynamically self-organize and self-configure, which can reduce installation overhead. The ability to self-configure enables dynamic distribution of workloads, particularly in the event a few nodes should fail. This, in turn, contributes to fault tolerance and reduced maintenance costs.

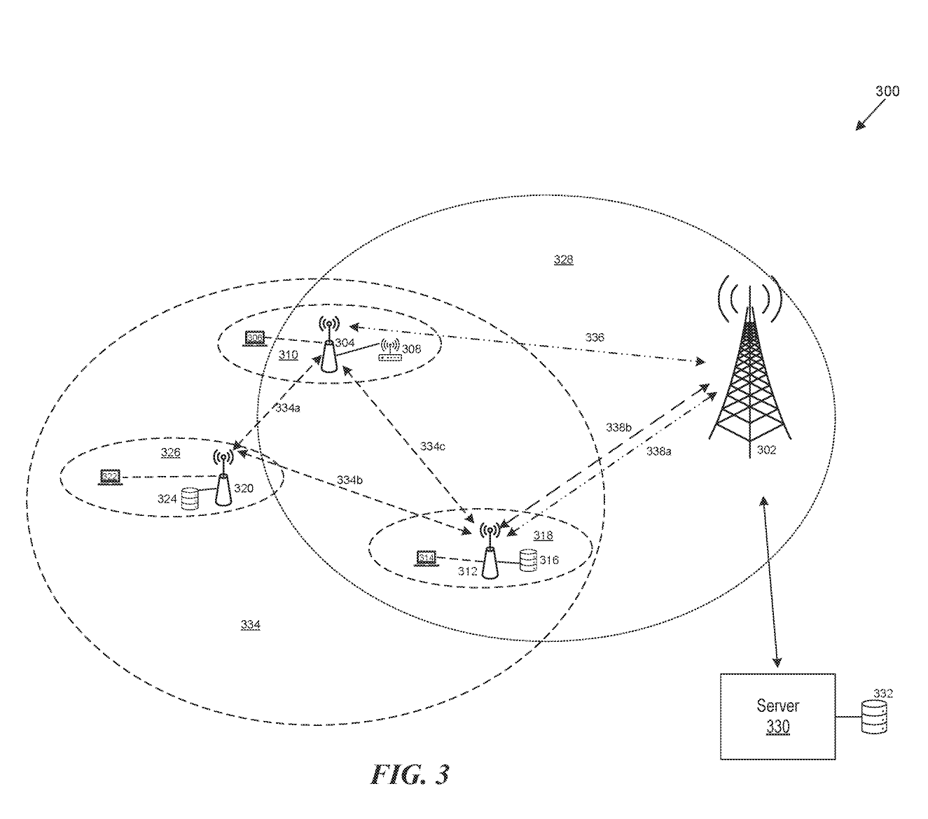

FIG. 3 is a system diagram of a system 300 in which at least some aspects of the disclosed technology are implemented. In some implementations, the system 300 can include a plurality of FWA devices 304, 312, and 320 that are configured to provide FWA service to a subscriber of a cellular network. Network node 302 is a RAN node of the cellular network configured to provide mobile communications service to the subscriber within a coverage footprint 328 of the network node 302.

In some implementations, the FWA devices 304, 312, and 320 can each be configured to provide internet access to electronic devices 306, 314, or 322 of a subscriber within a respective coverage footprint 310, 318, and 326. The coverage footprints 310, 318, and 326 can be referred to herein as an FWA local mesh network of the FWA devices 304, 312, and 320, respectively. In some implementations, the subscriber can be aware of the availability of the FWA local mesh network of the FWA device 304, 312, 320 for connecting the electronic devices 306, 314, 322. Each of the electronic devices 306, 314, 322 can be, for example, a phone, a laptop, a tablet, or another internet-capable device.

In some implementations, the coverage footprint can be extended by a local mesh extender device (e.g., device 308 shown in FIG. 3). In some implementations, the FWA device 312, 320 can include or be coupled with a network storage device 316, 324. In some implementations, the network storage device 316, 324 can be configured to function as a network cache (also referred to herein as network data cache) that stores a data packet received by, sent by, or transitioning through the FWA device 312, 320.

In some implementations, the FWA devices 304, 312, or 320 can be disposed within or at the edge of the coverage footprint 328 of the network node 302. For the purposes of the current illustration, FWA device 312 is disposed at a location within the coverage footprint 328 of the network node 302 such that FWA device receives a strong signal from the network node 302. For the purposes of the current illustration, FWA device 304 is disposed at a location near an edge of the coverage footprint 328 of the network node 302 such that FWA device receives a weak signal from the network node 302. For the purposes of the current illustration, FWA device 320 is disposed at a location outside the coverage footprint 328 of the network node 302 such that FWA device 320 does not receive a signal from the network node 302. The exact locations of the FWA devices 304, 312, and 320 may vary in relation to each other or in relation to the coverage footprint 328 of the network node 302 and are not to be construed as limiting. In some implementations, the FWA devices 304, 312, and 320 can be configured to connect to the cellular network represented by network node 302 using mobile communications protocols such as 4G, LTE, 5G, etc. In some implementations, the FWA devices 304, 312, and 320 can be configured to connect to the cellular network represented by network node 302 using FWA protocols. In some implementations, the FWA devices 304, 312, and 320 can be configured to provide home internet service to electronic devices 306, 314, and 322 using WiFi protocols. In some implementations, server 330 can be a remote server located within or outside the cellular network represented by the network node 302 and may be reachable by an electronic device 306, 314, or 322 of the subscriber via the network node 302. In some implementations, the server 330 can be coupled with a database 332 that hosts at least one data byte or at least one data packet to which electronic devices 306, 314, or 322 can request access.

In some implementations, FWA device 304 and FWA device 320 can be configured to establish a local P2P connection 334a with each other, FWA device 312 and FWA device 320 can be configured to establish a local P2P connection 334b with each other, and FWA device 312 and FWA device 304 can be configured to establish a local P2P connection 334c with each other. In some implementations, the local P2P connection 334a, 334b, 334c can use licensed or unlicensed frequencies. For example, the local P2P connection 334a, 334b, 334c can use WiFi protocols over unlicensed frequencies. In some implementations, the local P2P connections 334a, 334b, and 334c can be collectively referred to as an FWA global mesh network 334. In some implementations, when P2P connections 334a, 334b, and 334c are implemented using WiFi protocols, the FWA global mesh network 334 can be referred to herein as an FWA global WiFi mesh network. In some implementations, the subscriber can be unaware of the existence of the FWA global mesh network 334.

In some implementations, the network node 302 and the FWA device 304 can be configured to establish a network slice 336 for exchanging data that belong to a traffic flow with certain QoS attributes. In some implementations, the network node 302 and FWA device 312 can be configured to establish a plurality of network slices 338a and 338b for exchanging data that belongs to traffic flows with different QoS attributes. In some implementations, the network slice 336 can be configured to transfer a data packet containing latency-sensitive data between FWA device 304 and the network node 302. In some implementations, the network slice 338a can be configured to transfer a latency-sensitive data packet between FWA device 312 and the network node 302. A latency-sensitive data packet is a data packet that needs to be transferred from a sender of the data packet to a receiver of the data packet under a first delay threshold amount of time, for example, a data packet that belongs to a conversational voice, conversational video, real-time gaming, or network signaling data flow. These examples of latency-sensitive data packets are not to be construed to be limiting, and a person having ordinary skill in the art will recognize that the latency-sensitive data packet can belong to a variety of applications or data flows that can tolerate varying levels network latency and thus have varying levels of QoS requirements. In some implementations, the network slice 338b can be configured to transfer a bandwidth-intensive data packet between FWA device 304 and the network node 302. A bandwidth-intensive data packet is one that includes a large payload of data that is greater than a first size threshold. For example, the bandwidth-intensive data packet may include data from a file transfer, email, buffered streaming video, etc. These examples of bandwidth-intensive data packets are not to be construed to be limiting, and a person having ordinary skill in the art will recognize that the bandwidth-intensive data packet can belong to a variety of applications or data flows that can use varying levels of data packet sizes and thus have varying levels of QoS requirements. In some implementations, the network slice 338b can be configured to transfer a data packet that is bandwidth-intensive but is not latency-sensitive between FWA device 304 and the network node 302.

In some implementations of the disclosed technology, when FWA device 304 needs to transfer a latency-sensitive data packet to network node 302 or send a data packet to network node 302 with the least number of hops between FWA devices and network nodes, it can send the packet directly to the network node 302 via the network slice 336 using network resources, including licensed spectrum, of the network node 302. In some implementations, when FWA device 304 needs to send a bandwidth-intensive data packet that is not latency-sensitive to the network node 302, it can first forward the data packet to FWA device 312 over the P2P connection 334c and include a request to FWA device 312 to forward the data packet to the network node 302. Upon receiving the request or the data packet, the FWA device 312 can determine that it is not latency-sensitive and forward the data packet to the network node 302 over the network slice 338b.

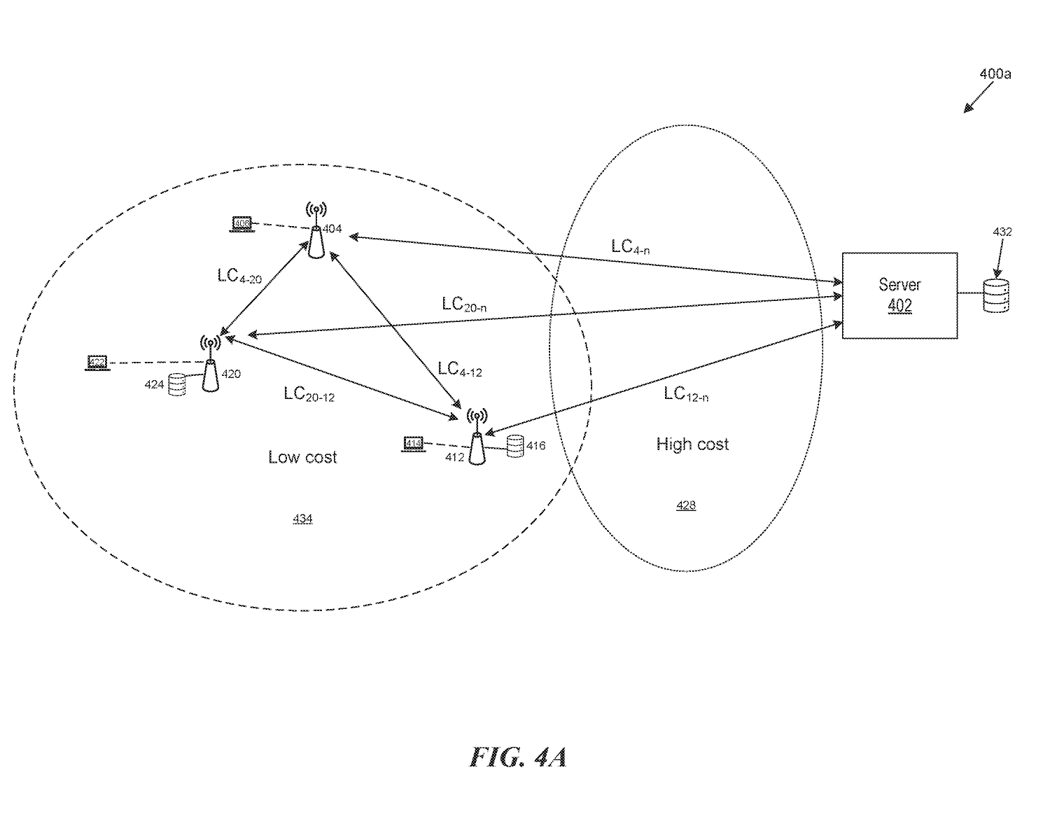

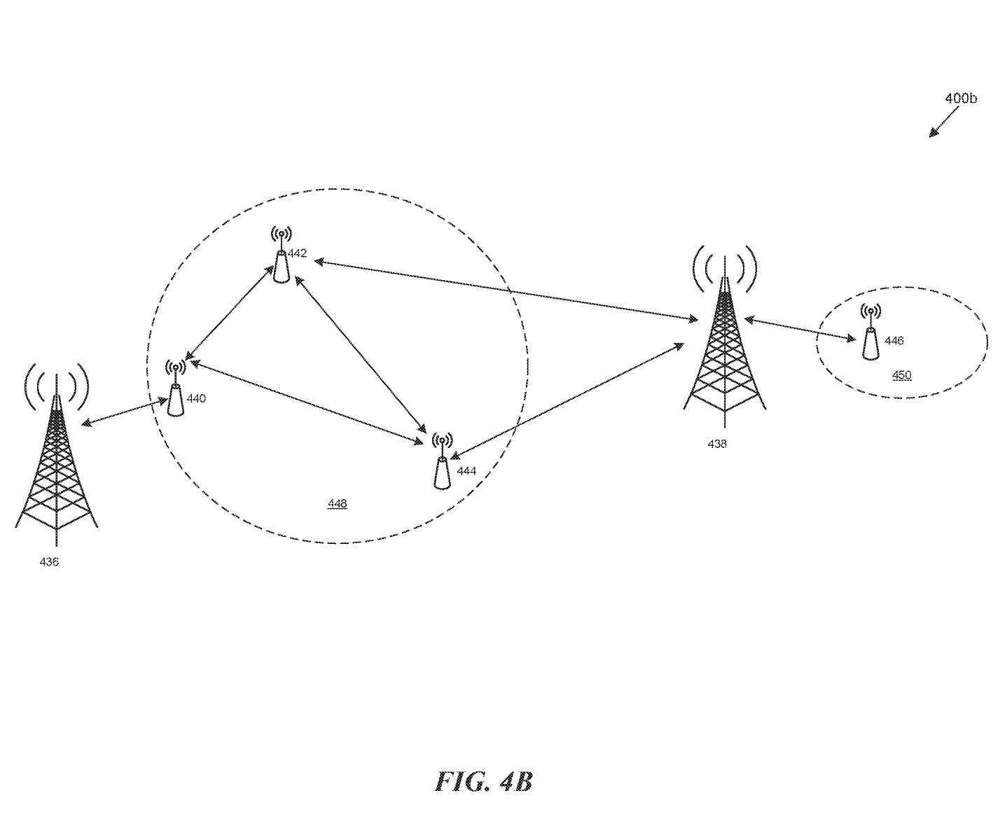

FIG. 4A is a link cost diagram of a system 400a in which at least some aspects of the disclosed technology are implemented. In some implementations, the system 400a can include a plurality of FWA devices 404, 412, and 420 that are configured to provide FWA service to a subscriber of the cellular network 428. In some implementations, each of FWA devices 404, 412, 420 can be configured to provide internet access to an electronic device 406, 414, 422 of the subscriber within a coverage footprint of the FWA device 404, 412, 420. In some implementations, the FWA device 412, 420 can include or be coupled with a network storage device 416, 424. In some implementations, the network storage device 416, 424 can be configured to function as a network data cache that stores a data packet received by, sent by, or transitioning through the FWA device 412, 420.

In some implementations, server 402 can be a remote server located within or outside the cellular network 428 and may be reachable by electronic devices 406, 414, or 422 of the subscriber via the cellular network 428. In some implementations, the server 402 can be coupled with a database 432 that hosts at least one data byte or at least one data packet to which electronic devices 406, 414, or 422 can request access.

In some implementations, FWA device 404 and FWA device 420 can be configured to establish a local P2P connection with each other, FWA device 412 and FWA device 420 can be configured to establish a local P2P connection with each other, and FWA device 412 and FWA device 404 can be configured to establish a local P2P connection with each other. In some implementations, the local P2P connection(s) can use licensed or unlicensed frequencies. For example, the local P2P connection between FWA devices 404 and 420 can use WiFi protocols over unlicensed frequencies. The local P2P connections among FWA devices 404, 412, and 404 can be collectively referred to as an FWA global mesh network 434. In some implementations, when the local P2P connections among FWA devices 404, 412, and 404 are implemented using WiFi protocols, the FWA global mesh network 434 can be referred to herein as an FWA global WiFi mesh network. In some implementations, the subscriber can be unaware of the existence of the FWA global mesh network 434. The FWA global mesh network 434 can be considered herein to be a low-cost network because it does not use network resources of the cellular network 428 for transferring data. The cellular network 428 can be considered a high-cost network herein because transferring data via the cellular network 428 increases uplink noise in the cellular network 428 and also reduces the available system capacity of the cellular network 428.

In some implementations of the disclosed technology, each of the FWA devices 404, 412, and 420 can determine and advertise to the other FWA devices in the FWA global mesh network a link cost for sending data from that FWA device to the server 402 via the cellular network 428. For example, FWA device 404 can determine and advertise a link cost LC₄₋ₙ for sending a data packet from FWA device 404 to the server 402 via the cellular network 428, FWA device 412 can determine and advertise a link cost LC₁₂₋ₙ for sending a data packet from FWA device 412 to the server 402 via the cellular network 428, and FWA device 420 can advertise a link cost LC₂₀₋ₙ for sending a data packet from FWA device 420 to the server 402 via the cellular network 428. In some implementations, FWA device 404 can determine the link cost LC₄₋ₙ based on at least one of a signal quality metric between FWA device 404 and the cellular network 428, a cellular capacity metric of the cellular network 428, or an FWA device capacity metric of the FWA device 404. In some implementations, FWA device 412 can determine the link cost LC₁₂₋ₙ based on at least one of a signal quality metric between FWA device 412 and the cellular network 428, a cellular capacity metric of the cellular network 428, or an FWA device capacity metric of the FWA device 412. In some implementations, FWA device 420 can determine the link cost LC₂₀₋ₙ based on at least one of a signal quality metric between FWA device 420 and the cellular network 428, a cellular capacity metric of the cellular network 428, or an FWA device capacity metric of the FWA device 420.

In some implementations, FWA device 404 can determine a link cost LC₄₋₁₂ for sending a data packet to FWA device 412 via the local P2P connection between those two FWA devices. In some implementations, FWA device 404 can determine the link cost LC₄₋₁₂ based on at least one of a signal quality metric between FWA device 404 and the FWA device 412 or a P2P link capacity metric between FWA device 404 and FWA device 412. In some implementations, FWA device 404 can determine a link cost LC₄₋₂₀ for sending a data packet to FWA device 412 via the local P2P connection between those two FWA devices. In some implementations, FWA device 404 can determine the link cost LC₄₋₂₀ based on at least one of a signal quality metric between FWA device 404 and the FWA device 420 or a P2P link capacity metric between FWA device 404 and FWA device 420. In some implementations, FWA device 420 can determine a link cost LC₂₀₋₁₂ for sending a data packet to FWA device 412 via the local P2P connection between those two FWA devices. In some implementations, FWA device 420 can determine the link cost LC₂₀₋₁₂ based on at least one of a signal quality metric between FWA device 420 and the FWA device 412 or a P2P link capacity metric between FWA device 420 and FWA device 412.

In some implementations, FWA device 404 can determine a total cost TC₁₂₋ₙ (not shown in figure) for sending a data packet to server 402 via FWA device 412 and the cellular network 428 by adding the link cost LC₄₋₁₂ for sending data from FWA device 404 to FWA device 412 and the link cost LC₁₂₋ₙ advertised by FWA device 412 for sending the data packet from FWA device 412 to server 402 via the cellular network 428. Expressed mathematically, TC₁₂₋ₙ = LC₄₋₁₂ + LC₁₂₋ₙ. FWA device 404 can further compare the link cost LC₄₋ₙ for sending the data packet from FWA device 404 to the server 402 via the cellular network 428 with the total cost TC₁₂₋ₙ for sending the data packet to server 402 via FWA device 412 and the cellular network 428. In some implementations, when LC₄₋ₙ is less than TC₁₂₋ₙ, the FWA device 404 can send the data packet to the server 402 directly via the cellular network 428 by using resources and capacity of the cellular network 428. In some implementations, when the data packet is latency-sensitive, FWA device 404 can send the data packet to the server 402 directly via the cellular network 428 by using resources and capacity of the cellular network 428 when LC₄₋ₙ is less than TC₁₂₋ₙ. In some implementations, when the data packet is latency-sensitive, FWA device 404 can send the data packet to the server 402 directly via the cellular network 428 by using resources and capacity of the cellular network 428 regardless of which of LC₄₋ₙ and TC₁₂₋ₙ is less. In some implementations, when the data packet is bandwidth-intensive, FWA device 404 can send the data packet to the server 402 via FWA device 412 when TC₁₂₋ₙ is less than LC₄₋ₙ. In some implementations, when the data packet is bandwidth-intensive, FWA device 404 can send the data packet to the server 402 via FWA device 412 regardless of which of LC₄₋ₙ and TC₁₂₋ₙ is less. In some implementations, FWA device 404 can determine whether to send a data packet to the server 402 directly via the cellular network 428 by using resources and capacity of the cellular network 428 or via FWA device 412 based on at least one QoS metric of the data packet. In some implementations, FWA device 404 can determine whether to send a data packet to the server 402 directly via the cellular network 428 by using resources and capacity of the cellular network 428 or via FWA device 412 based on a comparison of the link cost LC₄₋ₙand TC₁₂₋ₙ.

In some implementations, FWA device 404 can request data stored in network storage device 416 of FWA device 412. In response, FWA device 412 can retrieve the data from network storage device 416 and send it to FWA device 404. Both these data transfers can be performed directly between those two FWA devices using unlicensed spectrum or without utilizing resources of the cellular network 428. In some implementations, FWA device 412, upon receiving the data request from the FWA device 404, can first determine whether the requested data exists in the network storage device 416 of FWA device 412 and, upon determining that the data does not exist in the network storage device 416, can forward the data request via the cellular network 428 to retrieve the requested data from the server 402 that hosts the data in database 432. In some implementations, FWA device 412 can store in its network storage device 416 at least a subset of data received from FWA device 404 or FWA device 420. In some implementations, FWA device 412 can store in its network storage device 416 at least a subset of data received from the cellular network 428. In some implementations, FWA device 412 can determine the subset of data to be stored in its network storage device 416 based on a probability of the subset of data being requested by FWA device 404 or FWA device 420.

FIG. 4B is a network peering diagram of a system 400b of a cellular telecommunications network in which at least some aspects of the disclosed technology are implemented. In some implementations, the system 400b can include a first radio access node 436 and a second radio access node 438, each configured to provide access to one or more subscribers of the cellular telecommunications network. In some implementations, the system 400b can further include a plurality of devices 440, 442, 444, and 446, each configured to provide fixed-wireless access (FWA) service to one or more subscribers of the cellular telecommunications network. In some implementations, a first part of the plurality of devices 440, 442, 444, and 446, for example device 440, also referred to herein as the first device 440, can be configured to be in communication with the first radio access node 436 while concurrently being connected to a first local wireless network 448 using an unlicensed spectrum of frequencies. In some implementations, a second device 442 of a second part, for example devices 442 and 444, of the plurality of devices 440, 442, 444, and 446, can be configured to be in communication with the second radio access node 438 while concurrently being connected to the first local wireless network 448 using the unlicensed spectrum of frequencies. In some implementations, a third part of the plurality of devices 440, 442, 444, and 446, for example device 446, can be configured to be in communication with the second radio access node 438 while concurrently being connected to a second local wireless network 450 using the unlicensed spectrum of frequencies.

In some implementations, the system 400b can cause the first device 440 to discover a second device 442 or 444 of the second part of the plurality of devices 442 and 444. In some implementations, the system 400b can further cause the first device 440 to establish a connection with the second device 442 using the unlicensed spectrum of frequencies. In some implementations, the system 400b can further cause the first device 440 to determine a first link cost for routing a data packet directly to the first radio access node 436 using a spectrum of frequencies licensed for use by the cellular telecommunications network. In some implementations, the system 400b can further cause the first device 440 to receive a second link cost from the second device 442 for routing the data packet to the second radio access node 438 via the second device 442. In some implementations, the system 400b can further cause the first device 440 to route the data packet based on a comparison of the first link cost and the second link cost. In some implementations, the system 400b can further cause the first device 440 to route the data packet directly to the first radio access node 436 using a spectrum of frequencies licensed for use by the cellular telecommunications network upon the first link cost being lower than the second link cost. In some implementations, the system 400b can further cause the first device 440 to route the data packet indirectly to the second radio access node 438 via the second device 442 upon the second link cost being lower than the first link cost.

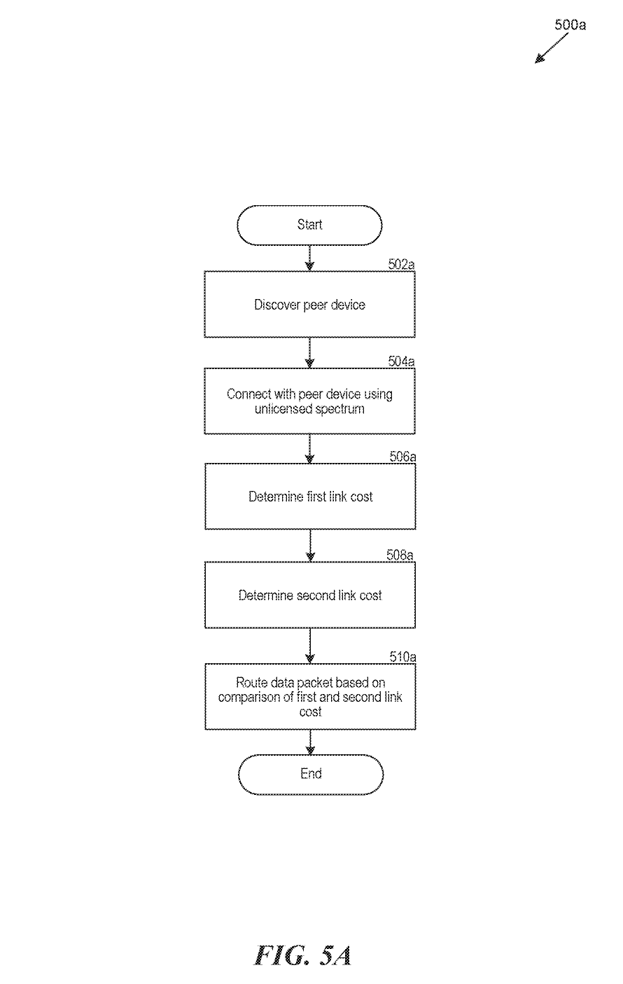

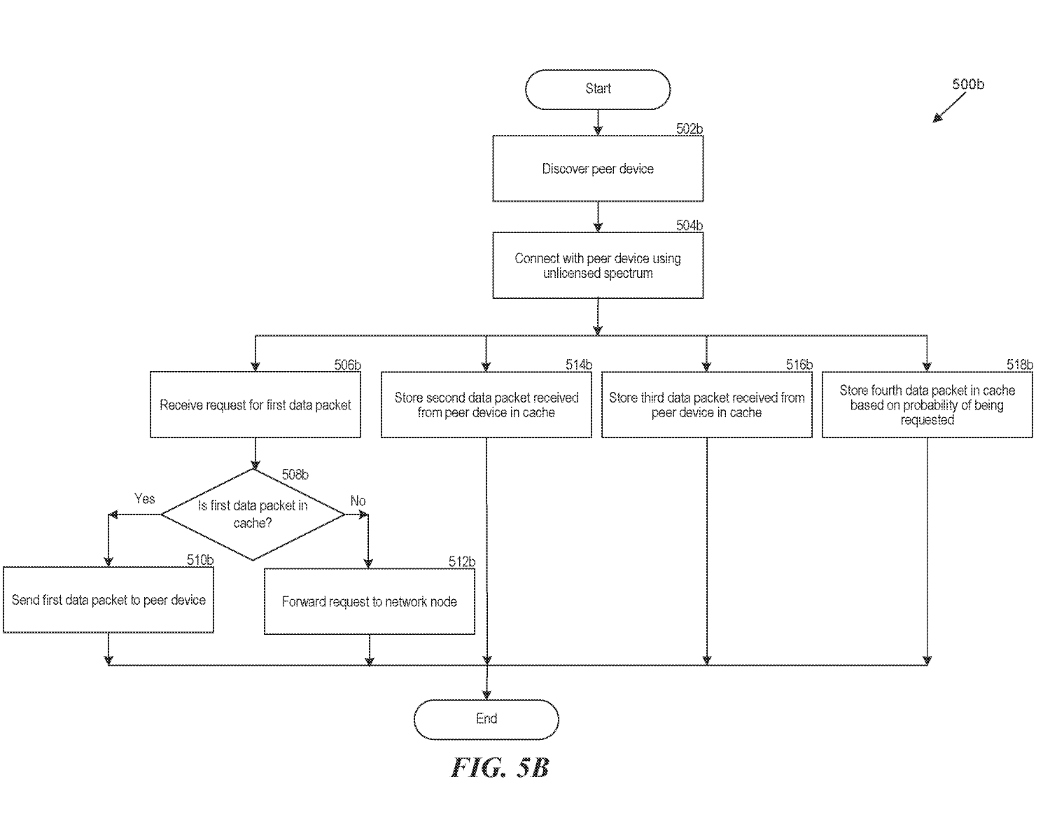

FIG. 5A is a flowchart of a process 500a for implementing at least some aspects of the disclosed technology. The process 500a can be implemented on a device configured to provide fixed-wireless access (FWA) service to a subscriber of a cellular telecommunications network. The device can be further configured to operate in the cellular telecommunications network while concurrently being connected to a local wireless network using an unlicensed spectrum of frequencies. In some implementations, the local wireless connection established between the device and the peer device can be a WiFi network. At 502a, the device can discover a peer device configured to provide FWA service to the subscriber in the local wireless network. At 504a, the device can establish a connection with the peer device using the unlicensed spectrum of frequencies. At 506a, the device can determine a first link cost for routing a data packet directly to a network node in the cellular telecommunications network using a spectrum of frequencies licensed for use by the cellular telecommunications network. At 508a, the device can determine a second link cost for routing the data packet indirectly to the network node via the peer device. In some implementations, the second link cost can be based at least on a combination of a third link cost and a fourth link cost received from the peer device. In some implementations, the third link cost can be based on at least a first link metric between the device and the peer device. In some implementations, the first link metric can be a signal quality metric between the device and the peer device, or a link capacity metric between the device and the peer device. In some implementations, the fourth link cost can be based on at least a second link metric between the peer device and the network node. In some implementations, the second link metric can be a signal quality metric between the peer device and the network node, a link capacity metric between the peer device and the network node, or a network capacity metric of the network node.

At 510a, the device can route the data packet based on a comparison of the first link cost and the second link cost. In some implementations, the device can route the data packet directly to the network node using a spectrum of frequencies licensed for use by the cellular telecommunications network when the first link cost is lower than the second link cost. In some implementations, the device can route the data packet directly to the network node using a spectrum of frequencies licensed for use by the cellular telecommunications network when the first link cost is lower than the second link cost and when the data packet is a latency-sensitive data packet that is required to be sent to a destination of the data packet in less than a first threshold period of time. In some implementations, the device can route the data packet indirectly to the network via the peer device when the second link cost is lower than the first link cost. In some implementations, the device can route the data packet indirectly to the network via the peer device when the second link cost is lower than the first link cost and when the data packet is a bandwidth-intensive data packet carrying a data payload greater than a second threshold size.

FIG. 5B is a flowchart of a process 500b for implementing at least some aspects of the disclosed technology. The process 500b can be implemented on a device configured to provide fixed-wireless access (FWA) service to the subscriber of the cellular telecommunications network. The device can include a network cache storage configured to store a data received by the device from a host of the data. The device can be configured to operate in the cellular telecommunications network while concurrently being connected to a local wireless network using an unlicensed spectrum of frequencies. At 502b, the device can discover a peer device configured to provide FWA service to the subscriber in the local wireless network. At 504b, the device can establish a connection with the peer device using the unlicensed spectrum of frequencies. At 506b, the device can receive, from the peer device over the local wireless network, a request to receive a first data packet. At 508b, the device can determine, in response to receiving the request from the peer device, whether the first data packet is stored in the network cache storage of the device and send the first data packet to the peer device or forward the request to a network node in the cellular telecommunications network using a spectrum of frequencies licensed for use by the cellular telecommunications network, based on the determination. At 510b, the device can, upon determining that the first data packet exists in the network cache storage of the device, send the first data packet to the peer device. At 512b, the device can, upon determining that the first data packet does not exist in the network cache storage of the device, forward the request to the network node. In some implementations, at 514b, the device can store a second data packet that is received by the device from the peer device in the network cache storage of the device. In some implementations, at 516b, the device can store a third data packet that is received by the device from the network node in the network cache storage of the device. In some implementations, at 518b, the device can store a fourth data packet that is received by the device from the network node in the network cache storage of the device based on a probability of the fourth data packet being requested by the peer device.

### Computer System

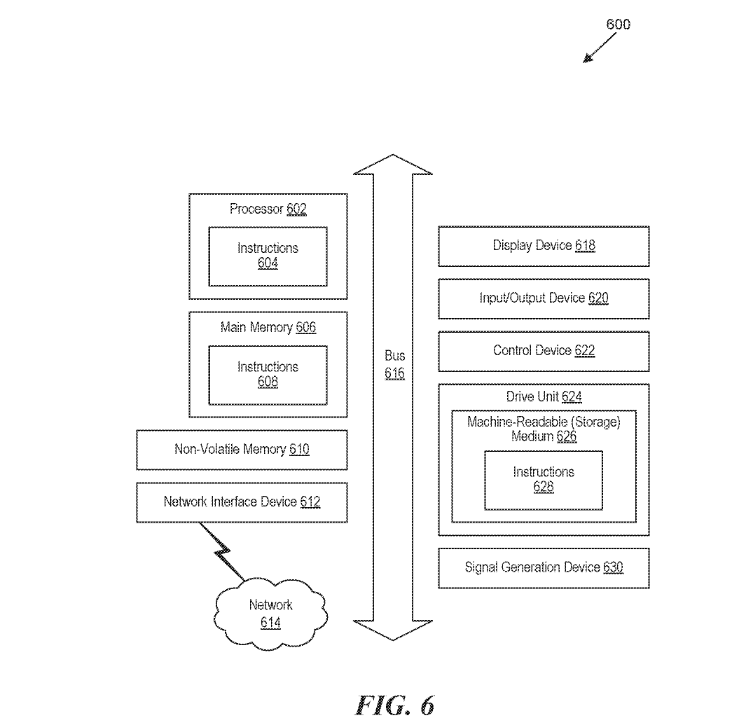

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, a video display device 618, an input/output device 620, a control device 622 (e.g., keyboard and pointing device), a drive unit 624 that includes a machine-readable (storage) medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computing system 600 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 600. In some implementations, the computer system 600 can be an embedded computer system, a system-on-chip (SOC), a single-board computer system (SBC), or a distributed system such as a mesh of computer systems, or it can include one or more cloud components in one or more networks. Where appropriate, one or more computer systems 600 can perform operations in real time, in near real time, or in batch mode.

The network interface device 612 enables the computing system 600 to mediate data in a network 614 with an entity that is external to the computing system 600 through any communication protocol supported by the computing system 600 and the external entity. Examples of the network interface device 612 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable medium 626 can include any medium that is capable of storing, encoding, or carrying a set of instructions for execution by the computing system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computing system 600 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for”. However, the use of the term “for” in any other context is not intended to invoke a similar interpretation. The applicant reserves the right to pursue such additional claim forms either in this application or in a continuing application.

We claim:

1. A device configured to provide fixed-wireless access (FWA) service to a subscriber of a cellular telecommunications network, the device comprising:
at least one hardware processor; and
at least one non-transitory memory storing instructions, which, when executed by the at least one hardware processor, cause the device to:
operate in the cellular telecommunications network while concurrently being connected to a local wireless network using an unlicensed spectrum of frequencies;
discover a peer device configured to provide FWA service to the subscriber in the local wireless network;
establish a connection with the peer device using the unlicensed spectrum of frequencies;
determine a first link cost for routing a data packet directly to a radio access node in the cellular telecommunications network using a spectrum of frequencies licensed for use by the cellular telecommunications network;
determine a second link cost for routing the data packet indirectly to the radio access node via the peer device; and
route the data packet based on a comparison of the first link cost and the second link cost.

2. The device of claim 1 caused to:
route the data packet directly to the radio access node using the spectrum of frequencies licensed for use by the cellular telecommunications network when the first link cost is lower than the second link cost.

3. The device of claim 1 caused to:
route the data packet indirectly to the radio access node via the peer device when the second link cost is lower than the first link cost.

4. The device of claim 1,
wherein the second link cost is based at least on a combination of a third link cost and a fourth link cost received from the peer device,
wherein the third link cost is based on at least a first link metric between the device and the peer device.

5. The device of claim 4,
wherein the first link metric is a signal quality metric between the device and the peer device or a link capacity metric between the device and the peer device.

6. The device of claim 4,
wherein the fourth link cost is based on at least a second link metric between the peer device and the radio access node.

7. The device of claim 6,
wherein the second link metric is a signal quality metric between the peer device and the radio access node, a link capacity metric between the peer device and the radio access node, or a network capacity metric of the radio access node.

8. The device of claim 1,
wherein the local wireless connection established between the device and the peer device is a WiFi network.

9. The device of claim 1 caused to:
route the data packet directly to the radio access node using a spectrum of frequencies licensed for use by the cellular telecommunications network when the first link cost is lower than the second link cost and when the data packet is a latency-sensitive data packet that is required to be sent to a destination of the data packet in less than a first threshold period of time.

10. The device of claim 1 caused to:
route the data packet indirectly to the radio access node via the peer device when the second link cost is lower than the first link cost and when the data packet is a bandwidth-intensive data packet carrying a data payload greater than a second threshold size.

11. A device configured to provide fixed-wireless access (FWA) service to a subscriber of a cellular telecommunications network, the device comprising:
at least one hardware processor;
a network cache storage configured to store a data packet received by the device from a host of the data; and
at least one non-transitory memory storing instructions, which, when executed by the at least one hardware processor, cause the device to:
operate in the cellular telecommunications network while concurrently being connected to a local wireless network using an unlicensed spectrum of frequencies;
discover a peer device configured to provide FWA service to the subscriber in the local wireless network;
establish a connection with the peer device using the unlicensed spectrum of frequencies;
receive, from the peer device over the local wireless network, a request to receive a first data packet;
determine, in response to receiving the request from the peer device, whether the first data packet is stored in the network cache storage of the device; and
send the first data packet to the peer device or forward the request to a radio access node in the cellular telecommunications network using a spectrum of frequencies licensed for use by the cellular telecommunications network based on the determination.

12. The device of claim 11 caused to:
upon determining that the first data packet exists in the network cache storage of the device, send the first data packet to the peer device.

13. The device of claim 11, caused to:
upon determining that the first data packet does not exist in the network cache storage of the device, forward the request to the radio access node.

14. The device of claim 11 further caused to:
store a second data packet in the network cache storage of the device,
wherein the second data packet is a data packet that is received by the device from the peer device.

15. The device of claim 11 further caused to:
store a third data packet in the network cache storage of the device,
wherein the third data packet is a data packet that is received by the device from the radio access node.

16. The device of claim 11 further caused to:
store a fourth data packet in the network cache storage of the device based on a probability of the fourth data packet being requested by the peer device,
wherein the fourth data packet is a data packet that is received by the device from the radio access node.

17. A system for a cellular telecommunications network comprising:
a first radio access node configured to provide access to the cellular telecommunications network;
a second radio access node configured to provide access to the cellular telecommunications network;
a plurality of devices each configured to provide fixed-wireless access (FWA) service to one or more subscribers of the cellular telecommunications network,
wherein a first part of the plurality of devices is configured to be in communication with the first radio access node while concurrently being connected to a first local wireless network using an unlicensed spectrum of frequencies, and
wherein a second part of the plurality of devices is configured to be in communication with the second radio access node while concurrently being connected to the first local wireless network using the unlicensed spectrum of frequencies;
at least one hardware processor; and
at least one non-transitory memory storing instructions, which, when executed by the at least one hardware processor, cause the system to cause a first device of the first part of the plurality of devices to:
discover a second device of the second part of the plurality of devices;
establish a connection with the second device using the unlicensed spectrum of frequencies;
determine a first link cost for routing a data packet directly to the first radio access node using a spectrum of frequencies licensed for use by the cellular telecommunications network;
receive a second link cost from the second device for routing the data packet to the second radio access node via the second device; and
route the data packet based on a comparison of the first link cost and the second link cost.

18. The system of claim 17, wherein a third part of the plurality of devices is configured to be in communication with the second radio access node while concurrently being connected to a second local wireless network using the unlicensed spectrum of frequencies.

19. The system of claim 17, wherein the first device of the first part of the plurality of devices is configured to:
route the data packet directly to the first radio access node using a spectrum of frequencies licensed for use by the cellular telecommunications network upon the first link cost being lower than the second link cost.

20. The system of claim 17, wherein the first device of the first part of the plurality of devices is configured to:
route the data packet indirectly to the second radio access node via the second device upon the second link cost being lower than the first link cost.
